(19) United States
(12) Patent Application Publication
(10) Pub. No.: US 2021/0171223 A1
(43) Pub. Date: Jun. 10, 2021

(54) Propulsion Systems Utilizing Gas Generated Via An Exothermically Decomposable Chemical Blowing Agent, and Spacecraft Incorporating Same

(71) Applicant: University of Vermont and State Agricultural College, Burlington, VT (US)

(72) Inventors: Michael Ryan McDevitt, Burlington, VT (US); Darren L. Hitt, Jericho, VT (US); Patrick Lee, South Burlington, VT (US); Sandra Romero Diez, Burlington, VT (US); Alex Golden, Waban, MA (US); Kevin Mongeon, Milton, VT (US); Jon Watts, Wallingford, VT (US); Lydia Hantsche, Burlington, VT (US); Matthew Shea, Elverson, PA (US)

(21) Appl. No.: 16/622,580

(22) PCT Filed: Jun. 12, 2018
(86) PCT No.: PCT/US2018/037068

§ 371 Date: Dec. 13, 2019

Related U.S. Application Data
(60) Provisional application No. 62/519,917, filed on Jun. 15, 2017.

(51) Int. Cl. B64G 1/40; B64G 1/10

(52) U.S. Cl. CPC B64G 1/409; B64G 1/402; B64G 1/10

(57) ABSTRACT

Propulsion systems that generate thrust from pressure generated by thermally decomposing a chemical blowing agent (CBA). In some embodiments, the CBA decomposes exothermically such that once thermal decomposition has been initiated, the thermal decomposition continues without additional energy input. In some embodiments, the CBA is utilized in a digital-microthruster array containing microthrusters that can be individually activated to provide thrust. In some embodiments, a CBA may be stored in one or more CBA-storage chambers that can be individually activated to charge and/or recharge a pressure tank that stores gas from the CBA decomposition under pressure for providing thrust. These and other embodiments are disclosed. Such propulsion systems can be used for any of a variety of spacecraft, including micro- and nano-satellites. Corresponding methods of generating thrust are also disclosed.

### RELATED APPLICATION DATA

This application claims the benefit of priority of U.S. Provisional Patent Application Ser. No. 62/519,917, filed on Jun. 15, 2017, and titled “PROPULSION SYSTEMS UTILIZING GAS GENERATED VIA AN EXOTHERMICALLY DECOMPOSED CHEMICAL BLOWING AGENT, AND SPACECRAFT INCORPORATING SAME”, which is incorporated by reference herein in its entirety.

### GOVERNMENT RIGHTS

This invention was made with government support under contract number NNX15AP86H awarded by the National Aeronautics and Space Administration. The government has certain rights in the invention.

### FIELD OF THE INVENTION

The present invention generally relates to the field of propulsion systems. In particular, the present invention is directed to propulsion systems utilizing gas generated via an exothermically decomposed chemical blowing agent, and spacecraft incorporating same.

### BACKGROUND

As the capabilities of small satellites (<180 kg) have matured, mission designers have begun to consider them for formation flying missions, such as multi-point Earth observations or synthetic aperture arrays for deep space exploration, that would be cost-prohibitive to perform with larger satellites. Small satellites are well-suited for these types of missions, as all of the elements can be launched simultaneously and for a fraction of the cost of traditional missions. There has been particular interest in missions designed around the CubeSat platform, as the supporting infrastructure for launching and deploying satellites built to this standard are already in place. Indeed, a number of CubeS at-based missions are in development, demonstrating the potential of the platform and the demand for continued improvement of the supporting technologies.

While current small satellite designs are considerably more capable than previous generations, to support these new mission concepts there is additional subsystem development required. Perhaps the most critical of these subsystems are propulsion systems capable of providing the relative position and orientation control necessary to enable on-orbit formation flying. Small satellite attitude control thrusters are particularly challenging as they must provide reliable, low impulse-bit operation while conforming to the size, weight, power, and cost constraints of the form factor. In addition to the technical challenges these propulsion systems must address, many of them face regulatory hurdles that will limit their adoption for small satellites. These regulations include propulsion systems that must meet range safety and secondary payload requirements that limit the storage tank pressurization, amount of stored chemical energy, and toxicity of the propellant. Those requirements immediately eliminate many propulsion options, and limit the efficacy of others.

### SUMMARY OF THE DISCLOSURE

In one implementation, the present disclosure is directed to a propulsion system that includes a chemical-blowing-agent chamber containing a predetermined amount of a chemical blowing agent, wherein the chemical blowing agent is in solid form and decomposes exothermically in response to an initial application of heat to a portion of the chemical blowing agent so as to initiate thermal decomposition of the portion; a heating element in thermal communication with the portion of the chemical blowing agent for initiating the thermal decomposition of the chemical blowing agent so as to form a propelling gas during operation of the propulsion system; and an exhaust region in fluid communication with the chemical-blowing-agent chamber, wherein, during operation of the propulsion system, the exhaust region exhausts the propelling gas so as to provide thrust.

In another implementation, the present disclosure is directed to a method of propelling a spacecraft. The method includes initiating, aboard the spacecraft and with an initial application of heat, thermal decomposition of a portion of a chemical blowing agent so as to generate a gas, wherein the chemical blowing agent is in solid form and decomposes exothermically in response to the initial application of heat to the portion of the chemical blowing agent; stopping the initial application of heat to the chemical blowing agent before all of the chemical blowing agent has exothermally decomposed; allowing the chemical blowing agent to continue to thermally decompose after stopping the initial application of heat so as to generate pressurized gas; and directing the pressurized gas offboard of the spacecraft so as to provide thrust to the spacecraft.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram of a chemical-blowing-agent (CBA) based propulsion system in accordance with aspects of the present invention;

FIG. 2 is an isometric view of a microsatellite that includes a CBA-based propulsion system having pressurized propulsion gas storage tank;

FIG. 3A is a partially transparent isometric view of the CBA-based propulsion system of FIG. 2;

FIG. 3B is a partially transparent end view of the CBA-based propulsion system of FIG. 2;

FIG. 3C is a side view of the CBA-based propulsion system of FIG. 2;

FIG. 4 is an isometric view of a microsatellite that includes a CBA-based propulsion system that includes a plurality of thruster-array devices;

FIG. 5 is an exploded side view of a CBA-based propulsion system that includes a burst disc for releasing propulsion gas in a burst impulse;

FIG. 6 is an isometric view of another example CBA-based propulsion system of the present disclosure;

FIG. 7 is a cross-sectional view of a tank portion of a CBA storage unit, showing an example heater arrangement;

FIG. 8 is an enlarged end view of the heater of FIG. 7; and

FIG. 9 is an enlarged cross-sectional partial view of one of the microthrusters of one of the thruster-array devices of FIG. 4.

### DETAILED DESCRIPTION

In some aspects, the present invention is directed to propulsion systems that use a solid-form (e.g., powder) chemical blowing agent (CBA) that decomposes exothermically to produce pressurized gas that is then exhausted to produce thrust for a vehicle, such as a spacecraft, and especially, but not limited to, microsatellites and nano-satellites. For the sake of convenience, the term “spacecraft” as used herein and in the appended claims, includes a satellite of any size and any other object put into space by humans and that includes one or more onboard propulsion systems. CBAs are a family of chemical compounds that produce a significant volume of gas as a result of thermally induced decomposition. They are commonly used as additives in polymer manufacturing and food production to reduce the density of the surrounding medium. The present inventors have found that CBAs are highly attractive as a propellant for space applications, as they are non-toxic, inert at temperatures below their activation temperature, and low cost due to their use in other industries. Examples of CBAs having these properties include azodicarbonamide, isocyanate, titanium hydride, and zirconium hydride, among others. A benefit of using a CBA is that it does not need to be stored under pressure during launch or any other phase of a mission; this is a tremendous safety benefit. As a detailed example, azodicarbonamide, C₂H₄N₄O₂, decomposes into a mixture of nitrogen (N2), carbon monoxide (CO), and carbon dioxide (CO2) in a ratio of 65:32:3. The residual solids are made up of urazole, biurea, cyanuric acid, urea, and ammonia salt.

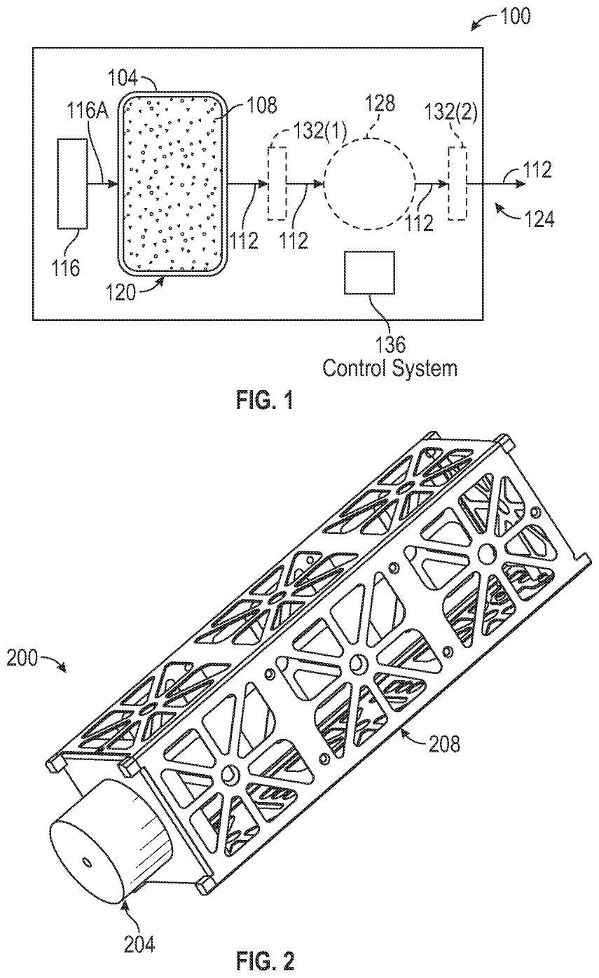

FIG. 1 illustrates some general components of a propulsion system made in accordance with aspects of the present invention. FIG. 1 shows an example propulsion system 100, which includes at least one CBA chamber, here a single CBA chamber 104, that initially contains a CBA 108 and functions as a decomposition chamber once the exothermic decomposition of the CBA has been initiated. As noted above, CBA 108 is in solid form, such as a powder, and has the property that it decomposes exothermically and produces a gas 112 (hereinafter call a “propulsion gas” based on its ultimate function) as a product of that decomposition. It is desirable that CBA 108 be non-combustible, non-toxic, and produce non-toxic gas upon thermal decomposition. Depending on the construction, CBA chamber 104 may be sealed, for example, using any suitable means, such as welding (e.g., electron beam, laser, ultrasonic, MIG, TIG, etc.), polymer O-rings, or metal seals, among others.

Propulsion system 100 also includes a heater 116 for providing initial heat 116A to at least a portion of CBA 108 to initiate thermal decomposition of the CBA. An important aspect of using an exothermic CBA is that only a relatively small amount of input energy is needed to produce a relatively large amount of output energy that can be used directly for propulsion. Heat from heater 116 only needs to be provided to initiate thermal decomposition of CBA 108. After thermal decomposition has started, the decomposition is self-sustaining, meaning the thermal decomposition continues, without the need for heat input from heater 116, until the original amount of CBA 108 has thermally decomposed into propulsion gas 112 and byproducts. Heater 116 can be any suitable heater that can raise the temperature of CBA 108, or a portion thereof, to the appropriate thermal decomposition temperature. Heater 116 includes, among other things, a heating element (not shown), such as an electric heating element, that may be placed inside or outside CBA chamber 104. CBA chamber 104 may be in a vessel 120, which, depending on the design of propulsion system 100, may be a pressure vessel or non-pressure vessel. In some embodiments, vessel 120 may include internal metallic features (not shown) that improve heating a surface area of the vessel exposed to CBA 108 within CBA chamber 104.

Propulsion system 100 further includes an exhaust region 124 for ultimately exhausting propulsion gas 112 from the propulsion system and offboard of the spacecraft (not shown) of which the propulsion system is part, so as to produce thrust for the spacecraft. In some embodiments and as will become apparent from examples below, exhaust region 124 may be, fluidly, immediately downstream of CBA chamber 104, whereas in some embodiments one or more other components, such as a pressure tank 128 and one or more valve assemblies, such as valve assemblies 132 (1) and 132 (2) are fluidly coupled between the CBA chamber and the exhaust region. Depending upon the design of propulsion system 100 and the needs of the spacecraft of which the propulsion system is a part, exhaust region 124 may be a simple exit orifice, a convergent nozzle, a divergent nozzle, or a convergent-divergent nozzle, among other things. Propulsion system 100 further includes a control system 136 that controls the operation of the propulsion system. One point of control that control system 136 may be programmed to perform is to control heater 116 so as to initiate thermal decomposition of CBA 108 at an appropriate time. For example, control system 136 may be suitably programmed to energize heater 116 for the time needed to initiate the thermal decomposition of a relatively small portion of CBA 108 within CBA chamber 104. Once the activation of heater 116 has initiated thermal decomposition, thermal decomposition of the remaining CBA 108 continues by virtue of the exothermic nature of the CBA. A benefit of leveraging the exothermic nature of CBA 108 is that the amount of CBA provided to any given CBA chamber, such as CBA chamber 104, can be scaled without needing to also scale the input energy needed to initiate the CBA's thermal decomposition. Once thermal decomposition of CBA 108 has been initiated with the initial input of energy, it continues without the need for additional energy input regardless of the amount of the CBA. Consequently, the total impulse (force multiplied by time) is likewise scalable generally with no change in input energy. This can results in significant savings of weight and cost relative to endothermic-reaction-based systems having similar total impulse outputs. As those skilled in the art will readily appreciate from reading this entire disclosure, control system 136 may control other aspects of propulsion system 100 and may base its control command(s) on input from one or more sensors (not shown), such as one or more pressure sensors, a position sensor, and an orientation sensor, among others. With these generalities in mind, following are descriptions of some example embodiments and experimental instantiations, along with some experimental results.

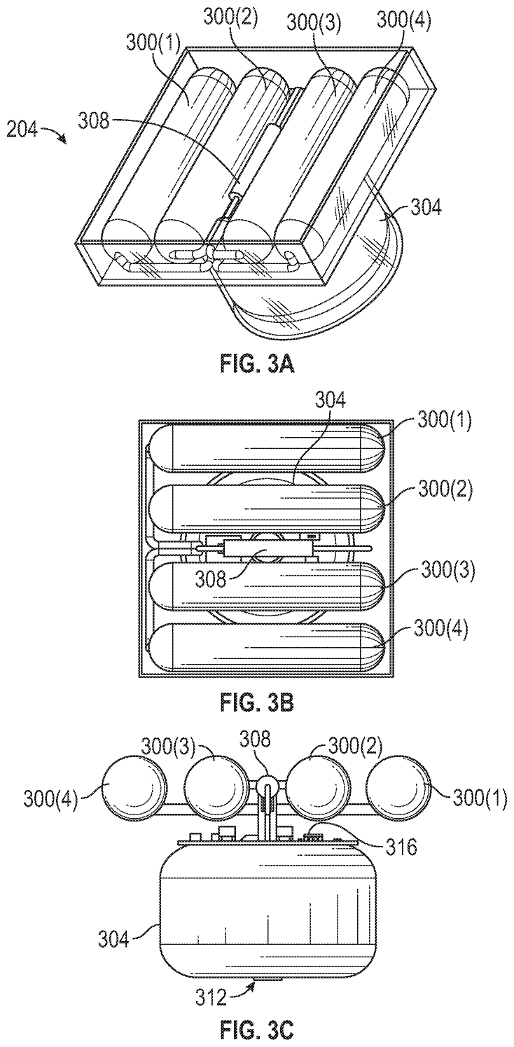

FIG. 2 illustrates a satellite, here, a microsatellite 200, that includes a CBA-based propulsion system 204 made in accordance with aspects of the present invention. In this example, CBA-based propulsion system 204 is secured to a frame 208 of microsatellite 200 and provides primary thrust for the microsatellite. Other systems aboard microsatellite 200 are not shown for sake of clarity. FIGS. 3A to 3C illustrate components of CBA-based propulsion system 204.

Referring now to FIGS. 3A to 3C, in this example CBA-based propulsion system 204 includes four CBA storage units 300 (1) to 300 (4) each having an internal chamber (not seen) containing a suitable CBA (not shown) in solid form and capable of thermally decomposing to form a propulsion gas. In the embodiment shown, the internal chamber functions both as a CBA storage chamber and a CBA decomposition chamber once thermal decomposition has been initialed. CBA-based propulsion system 204 also includes a pressure tank 304 and a valve assembly 308 fluidly coupled between the pressure tank and each of the four CBA storage units 300 (1) to 300 (4). In this example and as described below, valve assembly 308 isolates pressure tank 304 from CBA storage units 300 (1) to 300 (4) and isolates each CBA container from the other CBA container so as to minimize backflow from the pressure tank and to minimize energy loss. CBA-based propulsion system 204 includes an exhaust region 312, which may or may not include a nozzle (not shown). If a nozzle is included, it may be, for example, a monolithic and integrally-formed nozzle (formed, e.g., by 3D printing) or produced separately from pressure tank 304. Depending on the design of the CBA-based propulsion system, the nozzle may or may not be mechanically coupled to pressure tank 304. CBA-based propulsion system 204 may include a valve (not seen, but fluidly upstream of exhaust region 312) and/or a pressure regulator (not shown) fluidly coupled between pressure tank 304 and the exhaust region for controlling the flow of the propulsion gas through the exhaust region. Another example CBA-based propulsion system having such a valve and pressure regulator visible is shown in FIG. 6 and described below.

In this example, the manner of operation of CBA-based propulsion system 204 is to use the CBA in the four CBA storage units 300 (1) to 300 (4) to serially pressurize pressure tank 304 with the propulsion gas. For example, the thermal decomposition of the CBA in CBA storage unit 300 (1) may be used to initially pressurize pressure tank 304 from an unpressurized state, which may have been the state during launch of microsatellite 200 (FIG. 2). As an example, propulsion system 204 may be designed so that the maximum operating pressure of pressure tank 304 is 2000 psi. In this case, the amount of CBA in each CBA storage unit 300 (1) to 300 (4) may be such that, when the entire amount is completely thermally decomposed, the propulsion gas generated pressurizes pressure tank 304 to 2000 psi. Then, once the pressurized propulsion gas in pressure tank 304 has been used and the pressure has therefore reduced to a certain level, thermal decomposition of the CBA in another CBA storage unit, such as CBA storage unit 300 (2), can be initiated so that the self-sustaining exothermic reaction continues and generates propulsion gas that refills and re-pressurizes the pressure tank. This sequence can be repeated for each of the remaining CBA storage units.

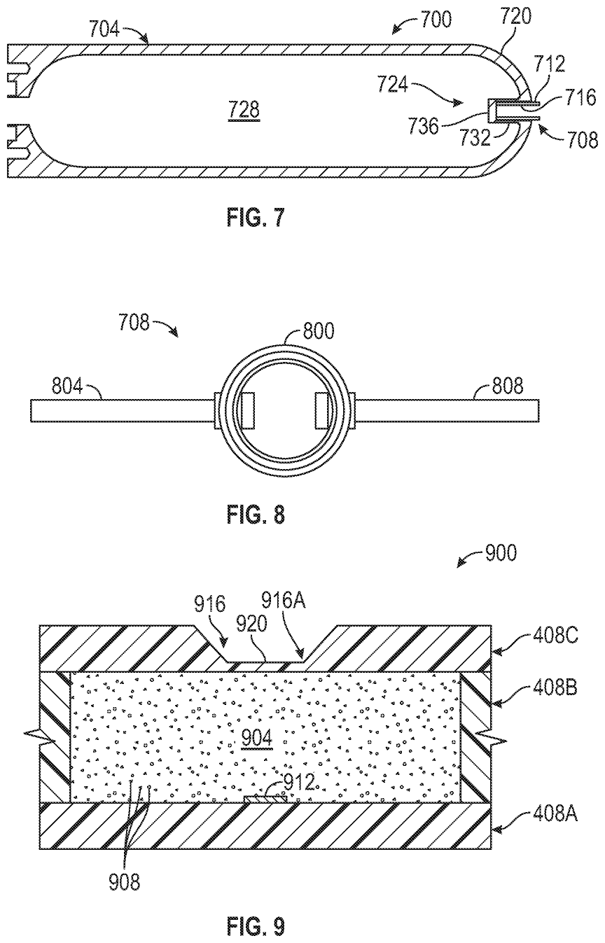

In this example, CBA-based propulsion system 204 may include a control system 316 that monitors pressure within pressure tank 304 via a suitable pressure sensor (not shown) and uses the resulting pressure readings, among other things, to determine when to activate a heater (not seen, but see, for example, FIGS. 7 and 8) of each CBA storage unit 300 (1) to 300 (4) to initiate the thermal decomposition of the CBA in a corresponding one of the CBA storage units. Control system 316 may also include algorithms for controlling any valve(s) (such as valve 320 between pressure tank 304 and exhaust region 312), heaters, and/or pressure regulator(s) provided as a function of the need for thrust for microsatellite 200 (FIG. 2). Not shown for ease of illustration are, among other things, a power source (e.g., battery(ies), solar panel(s), etc.) for powering control systems, heaters, and other electronics, such as valve solenoid(s) and wiring between control system 316 and the heaters, valve(s), sensor(s), and pressure regulator(s), among other things.

In one instantiation, microsatellite 200 (FIG. 2) is a CubeSat, and CBA-based propulsion system 204 is configured to occupy 0.2U and to take advantage of the CubeS at 3U+ standard, which includes an allowance for a propulsion system to, for example, extend into the “tuna can” space created by a launch spring of a poly-picosatellite orbital deployer (P-POD). For larger systems (6U, 12U, etc.), the system can be configured with additional storage units to increase the performance of the system, increase the output of the system, and/or otherwise change the characteristics of the system. In this instantiation, CBA-based propulsion system 204 may be designed to be a bolt-on propulsion option that provides primary propulsion for orbit maintenance, hazard avoidance, and/or de-orbiting without a major impact on the design of the system. All the electronics necessary to interface with the CubeSat bus (not shown) may be included in the system package, and one or more optional batteries (not shown), such as one or more lithium-ion batteries, can be used to provide the power to fire CBA-based propulsion system 204, i.e., heat the CBA in storage units 300 (1) to 300 (4), operate control system 316, and operate valve assembly 308 (FIG. 3A) and valve 320, making it a truly stand-alone propulsion option.

In this instantiation, CBA-based propulsion system 204 is designed to maximize the performance-to-cost ratio, which is particularly important for low-cost CubeSat missions. The low-cost is realized through extensive use of additive manufacturing and COTS parts and an inexpensive, non-toxic propellant that is safe to transport and handle. The performance characteristics of the 0.2U configuration are presented in the table below as an example.

| Parameter | Target Value | |
|---|---|---|
| Thrust | 5 | mN |
| Impulse-bit | 0.1 | mN · s |
| Total Impulse | 20 | N · s |
| Volume | 0.2 U + “tuna can” | |
| Mass | <350 | g |
| Power | <2 | W (peak) |

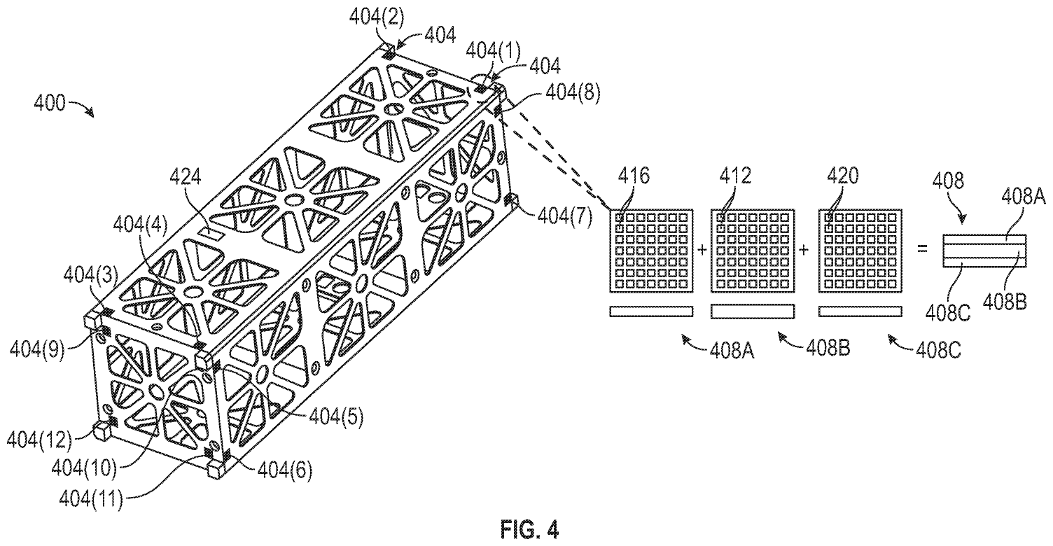

FIG. 4 illustrates a satellite 400 that includes a “digital” CBA-based propulsion system 404 that includes a plurality of digital thruster-array devices 404 (1) to 404 (24) (four on each of the six faces of the satellite; some not seen in FIG. 4) made in accordance with aspects of the present invention. In this example, each thruster-array device 404 (1) to 404 (24) comprises an array of microthrusters (not seen in FIG. 4, but see microthruster 900 of FIG. 9) that may be individually fireable to provide thrust in a digital manner. Depending on the thrust needs, one or more of the microthrusters can be fired at any particular time to create one or more “bits” of thrust. Each digital thruster-array device 404 (1) to 404 (24) may be formed as a micro-electromechanical system (MEMS) device 408 comprising, for example, a thermal reaction-initiation layer 408A, a CBA-storage layer 408B, and a micronozzle layer 408C made using any suitable MEMS fabrication technologies. CBA-storage layer 408B contains an array of storage+decomposition chambers 412 (only some labeled to avoid clutter) that function to store a CBA (not shown) until used and provide a space for containing the thermal decomposition of the CBA during firing of the corresponding microthruster. Each storage+decomposition chamber corresponds to a respective one of the microthrusters aboard MEMS device 408.

Thermal-initiation layer 408A includes an array of heaters 416 (only some labeled to avoid clutter), with each heater corresponding to one of the microthrusters aboard MEMS device 408. As described below, in some embodiments each heater 416 is individually actuatable relative to the other heaters so that the microthrusters aboard each MEMS device are individually fireable. Micronozzle layer 408C contains an array of micronozzles 420 (only some labeled to avoid clutter), with each micronozzle corresponding to one of the microthrusters aboard MEMS device 408. Each storage+reaction chamber may be sealed between the storage+decomposition chamber and micronozzle 420 using a burst disc.

In some embodiments, micronozzle layer 408C may be eliminated altogether or micronozzles 420 therein may be, for example, incorporated into the structure in which the storage+decomposition chambers are formed. As an example of the latter, a burst disc and a micronozzle may be integrated into a single structure (not shown) that may further be integrally formed with the structure of CBA-storage layer 408B.

In this connection, CBA-based propulsion system 404 may include one or more controllers 424 (only one shown for convenience) for controlling the firing of the microthrusters aboard thruster-array devices 404 (1) to 404 (24). For example, satellite 400 may be provided with a single controller, which controls all aspects of operation of the satellite. As another example, satellite 400 may be provided with a high-level mission controller that communicates with one or more propulsion-system controllers. If multiple propulsion-systems controllers are provided, one may be provided for each thruster-array device 404 (1) to 404 (24) or, alternatively, for some subgroup of the thruster-array devices. Not shown are the communications links (wired, wireless, or combination thereof) that allow the one or more controllers 424 to communicate with thruster-array devices 404 (1) to 404 (24) and/or one another and/or offboard controller or other device.

Not seen in FIG. 4 are the pressure-release devices, such as burst discs, that are present in the plurality of microthrusters aboard MEMS device 408. In this embodiment, each pres sure-release device is designed and configured to allow pressure to build within each CBA storage chamber 412 to a predetermined release pressure as the CBA contained therein thermally decomposes to form pressurized propulsion gas (not shown). When the propulsion gas reaches the release pressure, the pressure-release device opens, allowing the propulsion gas to exit MEMS device 408 through the corresponding micronozzle 420. If a burst disc is used, it may be provided to MEMS device 408 in any suitable manner, such as part of CBA-storage layer 408B (e.g., as a thinned wall) or part of micronozzle layer 408C (e.g., as a membrane covering the inlet of micronozzle 420) or in a separate layer sandwiched between the CBA-storage layer and the micronozzle layer, among other possibilities. While burst discs are simple, another type of pressure-release device, such as a valve, can be used. When pressure released from CBA-storage layer 408B is sudden, it creates a burst impulse. It is noted that the design of each micronozzle 420 may need to be tuned to minimize undesirable transient conditions within that micronozzle caused by the burst impulse.

Each MEMS device 408 may be any size and containing any number of microthrusters suitable for a given application. As one example, it is noted that current MEMS manufacturing capabilities allows for the creation of a 7 mm square array of microthrusters (see FIG. 9) with spacing for structural and thermal integrity, consisting of 19,600 individual microthrusters, each designed to provide about 1 micro-Newton of thrust. In some embodiments, materials for MEMS device 408 may include ceramic polymer compositions, polymer composites, and polymer metal composites, among others.

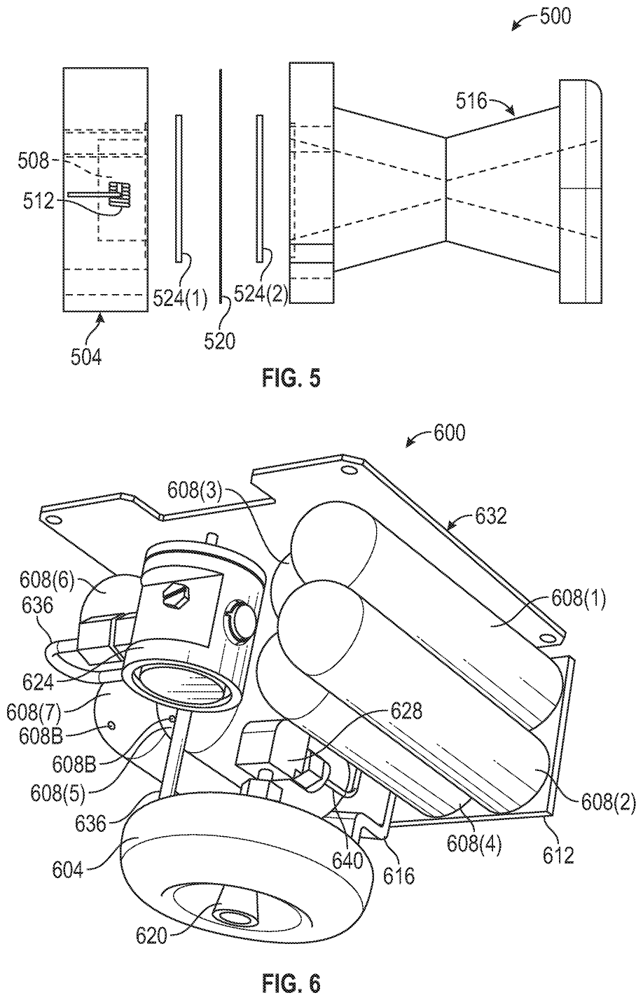

FIG. 5 illustrates a CBA-based propulsion system 500 that is similar in design to each of the microthrusters described above in connection with FIG. 4. However, in this example, CBA-based propulsion system 500 is embodied as a standalone device. In the example of FIG. 5, CBA-based propulsion system 500 includes a base portion 504 that includes a CBA chamber 508 and a heating element 512 extending into the CBA chamber. Though not shown, an exothermically decomposable CBA is placed in CBA chamber 508 prior to use of CBA-based propulsion system 500. Heating element 512 would then be energized to initiate the thermal decomposition of the CBA to generate propulsion gas. Heating element 512 may be, for example, a nichrome heating element, among others. In some embodiments in which heating element 512 is provided inside CBA chamber 508, the heating element may be surrounded by a tube (not shown) that is in fluid contact with the CBA but the inside of the tube is not exposed to the CBA-containing environment outside the tube.

CBA-based propulsion system 500 also includes a nozzle 516 and a burst disc 520 for optimizing the conversion of energy in the pressurized propelling gas into thrust. In this example, nozzle 516 is a C-D nozzle, but it could be a divergent nozzle, or it could be simply replaced by a plain orifice. Burst disc 520 is designed to rupture at a predetermined pressure, allowing the propelling gas formed within CBA chamber 508 to rapidly release in a burst impulse into nozzle 516. As those skilled in the art will readily appreciate, such a burst impulse may cause undesirable transient conditions within nozzle 516. Consequently, nozzle 516 may need to be specifically designed to minimize such transient conditions. In this example, burst disc 520 is separate and distinct from both of base portion 504 and nozzle 516 and is sealed between the base portion and nozzle using a pair of O-rings 524(1) and 524(2). In other embodiments, burst disc 520 may be integrated with either, or both, of base portion 504 and nozzle 516. Burst disc 520 may be made of any suitable material, such as metal, polymer, or ceramic, among others. In one example, burst disc 520 is composed a multiple layers of metal foil. In alternative embodiments, burst disc 520 may be replaced by a filter having a filtration size smaller than the size of particles of the CBA.

It is noted that while exothermically decomposable CBAs are used in the foregoing embodiments, some embodiments may use an endothermically decomposable CBA. However, exothermically decomposable CBAs are generally more desirable for many applications because of the lower input energy requirements and simplicity of operation. With exothermically decomposable CBAs, generally only enough energy to initiate thermal decomposition need be provided. Once the thermal decomposition starts, further decomposition is self-sustaining. In contrast, with endothermically decomposable CBAs, thermal decomposition occurs only while input energy is provided. Those skilled in the art can readily appreciate the positive impacts on spacecraft design and weight that the lower input energy requirements of exothermically decomposable CBAs have relative to endothermically decomposable CBAs.

FIG. 6 illustrates another example CBA-based propulsion system 600 that is generally similar to CBA-based propulsion system 204 of FIGS. 3A-3D. In this example, CBA-based propulsion system 600 includes a pressure tank 604, eight CBA storage units 608 (only six units 608 (1) to 608 (7) seen), a manifold 612, a gas conduit 616, a nozzle 620, a pressure regulator 624, a shutoff valve 628, and electronics 632. In this example, pressure tank 604 is toroidal in shape and includes a central opening 604A in which nozzle 620 is mounted. Each CBA storage unit 608 is fluidly connected to manifold 612, and the manifold is fluidly coupled to pressure tank 604 via gas conduit 616. In this example, pressure regulator 624 is fluidly coupled to pressure tank 604 downstream of the pressure tank via a conduit 636, shutoff valve 628 is fluidly coupled to the pressure regulator downstream of the pressure regulator via a conduit 640, and nozzle 620 is fluidly coupled to the shutoff valve downstream of the shutoff valve via a conduit 644. In this embodiment, each CBA storage unit 608 include a heater recess 608B (only a few visible in FIG. 6) for receiving a suitable heater (not shown, but see, e.g., FIGS. 7 and 8 for an example). Electronics 632 includes a control system (not shown) and other electronics for powering the components of CBA-based propulsion system 600 (e.g., heaters, shutoff valve 628, sensors (not shown), etc.) and controlling the operation of the CBA-based propulsion system. Not shown for clarity include the heaters, sensors (e.g., pressure sensors upstream and downstream of pressure regulator 624), and wiring to electrically connect-together electronics 632 and the various electrically powered components of CBA-based propulsion system 600. The control system includes appropriate algorithms for controlling the heaters, shutoff valve 628, pressure regulator 624, as a function of the state of CBA-based propulsion system 600 (e.g., pressures, number of unused CBA storage units, etc.) and the propulsion needs of the satellite or spacecraft to which the CBA-based propulsion system is coupled.

As a non-limiting example, in one instantiation pressure tank 604 and each of CBA storage units 608 are designed to be pressurized to a working pressure of 1000 PSI and nozzle 620 is designed to operate at 50 PSI, with pressure regulator 624 providing the appropriate stepdown in pressure. In this instantiation, each CBA storage unit is provided with an amount of CBA (not shown) needed to, upon ignition and thermal decomposition, raise the pressure within the pressure tank to 1000 PSI, or there-about, from a depleted pressure level. In the embodiment shown, there are no valves between CBA storage units 608 and pressure tank 604, and the pressure tank is in constant fluid communication with the CBA storage units via manifold 612 and gas conduit 616 such that the total volume pressurized by thermal decomposition of the CBA in any given CBA storage unit is composed of the volume of the pressure tank, the volume of the CBA storage unit in which the CBA was just decomposed (less solid reaction byproducts), the unoccupied volume of any other CBA storage unit, the volume of the manifold, the volume of the gas conduit, the volume of conduit 636, and any higher-pressure-side volume of pressure regulator 624. Consequently, unless the amounts of CBA in CBA storage units 608 are precisely tuned to the varying total volume and are thermally decomposed in a specific sequence, the actual pressure within pressure tank 604, and indeed in the entire volume, will vary from 1000 PSI. In one instantiation, some or all of the major components of CBA-based propulsion system 600, such as pressure tank 604, CBA storage units 608, manifold 612, gas conduit 616, and nozzle 620 may be 3D printed using suitable 3D-printing techniques.

FIG. 7 illustrates a portion of a CBA storage unit 700 that can be used as a CBA storage unit of any suitable embodiment of a CBA-based propulsion system of the present disclosure, such as CBA-based propulsion systems 204, 600 of FIGS. 2 and 6, respectively. FIG. 7 shows CBA storage unit 700 as including a storage tank 704 and a heater 708. In this example, storage tank 704 is designed for a working pressure of 3000 PSI or more, such pressure resulting from thermal decomposition of a CBA (not shown) contained within the storage tank and, if forming part of a larger volume with one or more other CBA storage units (not shown, but see FIG. 6), thermal decomposition of the CBA contained within such other storage unit(s).

In this embodiment, heater 708 includes a heating element 712, for example, a ceramic heating element, at least partially located in a recess 716 formed in a wall 720 of storage tank 704. In this example, recess 716 is cylindrical and is partially defined by a protrusion 724 that extends into the interior 728 of storage tank 704. In the example shown, protrusion 724 is defined by a sidewall 732 and an end wall 736. Tank wall 720 and side and end walls 732, 736 of protrusion 724 may be monolithically formed with one another, such as by 3D printing, casting, machining, etc., to provide robustness and pressure-tightness. When storage tank 704 is charged with a suitable amount of CBA, such CBA is in direct contact with protrusion 724 to maximize the heat transfer from heater 708, through the protrusion, and into the CBA to initiate the thermal decomposition of CBA efficiently.

As seen in FIG. 8, in this example, heater 708 includes an electrically resistive element 800, such as a resistive ceramic element, and a pair of electrical conductors 804 and 808 electrically connected to a suitable electrical power source (not shown). Electrically resistive element 800 may be made of any suitable material and may be any suitable shape. In some embodiments, the material(s) selected for protrusion 724 and, as desired, tank wall 720 in general, should have a relatively high thermal conductivity to maximize efficiency. While heater 708 is shown at one end of storage tank 704, it is noted that it may be located at a different location on the storage tank and that the location of the heater may affect overall performance of the CBA-based propulsion system.

FIG. 9 illustrates an example microthruster 900 that can be a microthruster of any digital CBA-based propulsion system made in accordance with the present disclosure, such as digital CBA-based propulsion system 404 of FIG. 4. For the sake of convenience, microthruster 900 is described in the context of each thruster-array device 404 (1) to 404 (24) of FIG. 4. Referring to FIG. 9, and also to FIG. 4, microthruster 900 comprises thermal reaction-initiation layer 408A, CBA-storage layer 408B, and micronozzle layer 408C. Together, layers 408A, 408B, and 408C define a CBA-storage chamber 904 that contains a suitable CBA 908. In this example, thermal reaction-initiation layer 408A includes an electrically resistive element 912 that is individually powerable using any suitable addressing scheme to initiate the thermal decomposition of CBA 908. Not shown are electrical conductors that supply electrical current to resistive element 912 during use, as well as the addressing circuitry, among other things. In this example, micronozzle layer 408C may be considered to include both a nozzle 916 and a burst disc 920 located at the throat 916A of the nozzle. Burst disc 920 may have any suitable design and be made of any suitable material that allows it to rupture at a desired pressure caused by the decomposition of CBA 908 within storage chamber 904. Although nozzle 916 is shown as being a divergent nozzle, it may be a convergent-divergent nozzle or a convergent nozzle, among others.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention. The original appended claims form part of the original disclosure as if they appear in this Detailed Description section.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A propulsion system, comprising:
a chemical-blowing-agent chamber containing a predetermined amount of a chemical blowing agent, wherein the chemical blowing agent is in solid form and decomposes exothermically in response to an initial application of heat to a portion of the chemical blowing agent so as to initiate thermal decomposition of the portion;
a heating element in thermal communication with the portion of the chemical blowing agent for initiating the thermal decomposition of the chemical blowing agent so as to form a propelling gas during operation of the propulsion system; and
an exhaust region in fluid communication with the chemical-blowing-agent chamber, wherein, during operation of the propulsion system, the exhaust region exhausts the propelling gas so as to provide thrust.

2. The propulsion system according to claim 1, wherein the chemical blowing agent is non-combustible and non-toxic.

3. The propulsion system according to claim 1, wherein the propelling gas contains less than 10% carbon dioxide.

4. The propulsion system according to claim 1, further comprising a pressure-release device fluidly coupled between the chemical-blowing-agent chamber and the exhaust region, the pressure-release device designed and configured to release the propelling gas from the chemical-blowing-agent chamber when the propelling gas reaches a predetermined release pressure within the chemical-blowing-agent chamber.

5. The propulsion system according to claim 4, wherein the pressure-release device comprises a burst disc that releases the propelling gas at the predetermined release pressure in a burst impulse.

6. The propulsion system according to claim 5, wherein the exhaust region is configured to minimize transient conditions due to the burst impulse.

7. The propulsion system according to claim 4, wherein the chemical-blowing-agent chamber, the heating element, the exhaust region, and the pressure-release device are integrated into a MEMS device.

8. The propulsion system according to claim 4, wherein the MEMS device contains a plurality of each of the chemical-blowing-agent chamber, the heating element, the exhaust region, and the pressure-release device so as to form a plurality of individually fireable microthrusters.

9. The propulsion system according to claim 1, further comprising a pressure tank fluidly coupled between the chemical-blowing-agent chamber and the exhaust region.

10. The propulsion system according to claim 9, comprising a plurality of each of the chemical-blowing-agent chamber and the heating element, wherein each chemical-blowing-agent chamber is fluidly coupled with the pressure tank and contains the chemical blowing agent.

11. The propulsion system according to claim 10, further comprising a first valve assembly fluidly coupled between the exhaust region and the pressure tank.

12. The propulsion system according to claim 10, wherein the pressure tank is designed for a maximum operating pressure and each chemical-blowing-agent chamber contains only an amount of the chemical blowing agent that, in response to complete thermal decomposition of the amount, pressurizes the pressure tank to the maximum operating pressure.

13. The propulsion system according to claim 10, further comprising a control system programmed to initiate, in a serial manner, thermal decomposition of the chemical blowing agent in each of the plurality of chemical-blowing-agent chambers when pressure within the pressure tank is below a threshold pressure so as to recharge the pressure tank.

14. The propulsion system according to claim 10, further comprising a manifold fluidly coupled between all of the chemical-blowing-agent chambers and the pressure tank.

15. The propulsion system according to claim 10, further comprising a pressure regulator fluidly coupled between the pressure tank and the exhaust region.

16. The propulsion system according to claim 1, wherein the heating element extends into the chemical blowing agent within the chemical-blowing-agent chamber.

17. The propulsion system according to claim 1, wherein the exhaust region includes a convergent-divergent nozzle.

18. The propulsion system according to claim 1, wherein the chemical blowing agent has a complete-decomposition time that it takes for the entirety of the chemical blowing agent to completely thermally decompose, the propulsion system further comprising a control system programmed to activate the heating element for a time less than the complete-decomposition time.

19. A spacecraft comprising the propulsion system of claim 1.

20. A spacecraft according to claim 19, wherein the spacecraft is a satellite.

21. A method of propelling a spacecraft, comprising:
initiating, aboard the spacecraft and with an initial application of heat, thermal decomposition of a portion of a chemical blowing agent so as to generate a gas, wherein the chemical blowing agent is in solid form and decomposes exothermically in response to the initial application of heat to the portion of the chemical blowing agent;
stopping the initial application of heat to the chemical blowing agent before all of the chemical blowing agent has exothermally decomposed;
allowing the chemical blowing agent to continue to thermally decompose after stopping the initial application of heat so as to generate pressurized gas; and
directing the pressurized gas offboard of the spacecraft so as to provide thrust to the spacecraft.

22. The method according to claim 21, further including releasing the pressurized gas when it reaches a predetermined pressure.

23. The method according to claim 22, wherein the releasing of the pressurized gas includes releasing the pressurized gas as a burst impulse.

24. The method according to claim 21, wherein the directing of the pressurized gas includes directing the pressurized gas through a convergent-divergent nozzle.

25. The method according to claim 21, further comprising storing the pressurized gas in a pressure tank prior to directing the pressurized gas offboard of the spacecraft.

26. The method according to claim 25, wherein the chemical blowing agent is stored in a plurality of chemical-blowing-agent chambers, and the method further comprises serially initiating thermal decomposition amongst the plurality of chemical-blowing-agent chambers so as to serially pressurize the pressure tank.

27. The method according to claim 26, wherein the pressure tank has a maximum operating pressure and the method further comprises:
determining whether or not a pressure within the pressure tank falls below a threshold level below the maximum operating pressure;
when the pressure falls below the threshold level, initiating thermal decomposition of the chemical blowing agent in a next one of the chemical-blowing-agent chambers; and
allowing the thermal decomposition to continue so that the chemical blowing agent in the next one of the chemical-blowing-agent chambers thermally decomposes so as to re-pressurize the pressure tank to the maximum operating pressure.

28.-54. (canceled)
